(19) United States
(12) Patent Application Publication
(10) Pub. No.: US 2016/0086576 A1
(43) Pub. Date: Mar. 24, 2016

(54) DISPLAY DEVICE INCLUDING A BACKLIGHT UNIT

(71) Applicant: SAMSUNG DISPLAY CO., LTD., Yongin-City (KR)

(72) Inventor: JAEHYUN CHO, Seoul (KR)

(21) Appl. No.: 14/741,563

(22) Filed: Jun. 17, 2015

(30) Foreign Application Priority Data
Sep. 23, 2014 (KR) 10-2014-0126741

(51) Int. Cl. G09G 5/10; H05B 33/08

(52) U.S. Cl. CPC G09G 5/10; H05B 33/0854; G09G 2320/0626; G09G 2310/08; G09G 2360/14

(57) ABSTRACT

A display device is provided. The display device includes a display panel driving unit and a backlight unit. The display panel driving unit generates a data signal to display an image on a display panel of the display device and to output a first light control signal and a second light control signal in response to a mode signal. The backlight unit provides first light having a first color to the display panel in response to the first light control signal and provides second light having a second color to the display panel in response to the second light control signal. The display panel driving unit adjusts a pulse width of the first light control signal or a pulse width of the second light control signal in response to the dimming signal.

### CROSS-REFERENCE TO RELATED APPLICATION

This U.S. non-provisional patent application claims priority under 35 U.S.C. §119 to Korean Patent Application No. 10-2014-0126741, filed on Sep. 23, 2014, in the Korean Intellectual Property Office (KIPO), the disclosure of which is incorporated by reference herein in its entirety.

### TECHNICAL FIELD

The present invention relates to a display device including a backlight unit.

### DISCUSSION OF THE RELATED ART

A display panel in a display device such as a liquid crystal display device may include a backlight unit for supplying light to the display panel. The backlight unit may be formed by employing a light emitting diode (LED) to reduce power consumption and increase color reproduction. A backlight unit formed by employing the LED as a light source may have high brightness, however, as the backlight unit operates for a long time, the brightness may be lowered and a color coordinate of the generated light may change.

### SUMMARY OF THE INVENTION

According to an exemplary embodiment of the present invention, a display device is provided. The display device includes a display panel driving unit and a backlight unit. The display panel is configured to generate a data signal to display an image on a display panel of the display device and to output a first light control signal and a second light control signal in response to a mode signal. The backlight unit is configured to provide first light having a first color to the display panel in response to the first light control signal. The backlight unit is configured to provide second light having a second color different from the first color to the display panel in response to the second light control signal. The display panel driving unit adjusts a pulse width of the first light control signal or a pulse width of the second light control signal in response to the dimming signal.

In an exemplary embodiment of the present invention, the dimming signal may include a first dimming signal and a second dimming signal. The display panel driving unit may adjust the pulse width of the first light control signal in response to the mode signal and the first dimming signal, and adjust the pulse width of the second light control signal in response to the mode signal and the second dimming signal.

In an exemplary embodiment of the present invention, the display panel may display the image by a unit of a frame. The display panel driving unit may output the first light control signal to emit the first light in a first sub frame of the unit of the frame, and output the second light control signal to emit the second light in a second sub frame of the unit of the frame.

In an exemplary embodiment of the present invention, the backlight unit may include a first light source, a second light source, and a backlight controller. The first light source may provide the first light. The second light source may provide the second light. The backlight controller may drive the first light source in response to the first light control signal and drive the second light source in response to the second light control signal.

In an exemplary embodiment of the present invention, the display panel may include a plurality of sub-pixels, a plurality of gate lines, and a plurality of data lines. Each of the plurality of sub-pixels may be connected to one of the plurality of gate lines and one of the plurality of data lines. The display panel driving unit may include a gate driver, a data driver, and a timing controller. The gate driver may drive the plurality of gate lines. The data driver may drive the plurality of data lines. The timing controller may control the gate driver and the data driver, and output the first light control signal and the second light control signal in response to the first dimming signal and the second dimming signal, respectively.

In an exemplary embodiment of the present invention, the display panel driving unit may include a memory. The memory may store a first high-brightness pulse width and a first low-brightness pulse width corresponding to the first light control signal, and store a second high-brightness pulse width and a second low-brightness pulse width corresponding to the second light control signal.

In an exemplary embodiment of the present invention, the display device may include an optical sensor. The optical sensor may detect an amount of light from the backlight unit and output a light detection signal based on the detected amount of the light. The display panel driving unit may adjust the first high-brightness pulse width, the first low-brightness pulse width, the second high-brightness pulse width, or the second low-brightness pulse width based on a first difference in level between the data signal and the light detection signal.

In an exemplary embodiment of the present invention, the display panel driving unit may adjust the second high-brightness pulse width to be broader than the first high-brightness pulse width when the first difference is greater than a reference value.

In an exemplary embodiment of the present invention, when the mode signal represents a high-brightness mode, the display panel driving unit may output the first light control signal having a first pulse width corresponding to the first high-brightness pulse width and output the second light control signal having a second pulse width corresponding to the second high-brightness pulse width.

In an exemplary embodiment of the present invention, when the mode signal represents a low-brightness mode, the display panel driving unit may output the first light control signal having a first pulse width corresponding to the first diming signal by referring to the first low-brightness pulse width and output the second light control signal having a second pulse width corresponding to the second diming signal by referring to the second low-brightness.

In an exemplary embodiment of the present invention, the second pulse width may be broader than the first pulse width.

In an exemplary embodiment of the present invention, the display devices may further include an optical sensor. The optical sensor may detect an amount of light from the backlight unit and output a light detection signal based on the detected amount of the light. The timing controller may adjust pulse widths of the first light control signal and the second light control signal in response to the light detection signal.

In an exemplary embodiment of the present invention, the display panel may include a plurality of sub-pixels, a first color filter, a second color filter, and an open part. The first color filter, the second color filter, and the open part may be sequentially arranged in a first direction in one-to-one correspondence to the sub-pixels.

In an exemplary embodiment of the present invention, the first color filter may be a red color filter. The second color filter may be a green color filter.

In an exemplary embodiment of the present invention, the first color may be a yellow color. The second color may be a blue color.

According to an exemplary embodiment of the present invention, a display device is provided. The display device includes a display panel, a backlight unit, a timing controller, and an optical sensor. The display panel displays an image. The backlight unit is configured to provide first light having a first color to the display panel in response to a first light control signal, and to provide second light having a second color different from the first color to the display panel in response to a second light control signal. The timing controller is configured to output the first light control signal and the second light control signal in response to a light detection signal. The optical sensor is configured to detect an amount of light emitted from the backlight unit and to output a light detection signal based on the amount of the light.

In an exemplary embodiment of the present invention, a pulse width of the first light control signal or a pulse width of the second light control signal may be adjusted according to a level of the light detection signal.

In an exemplary embodiment of the present invention, the timing controller may include a memory. The memory may store pulse width information of the first and second light control signals.

In an exemplary embodiment of the present invention, the timing controller may further include a dimming control unit. The dimming control unit may output the first and second light control signals based on both of the light detection signal and the pulse width information.

In an exemplary embodiment of the present invention, the first color may be a yellow color. The second color may be a blue color.

### BRIEF DESCRIPTION OF THE DRAWINGS

Exemplary embodiment of the present invention will be more clearly understood from the following description taken in conjunction with the accompanying drawings, in which:

FIG. 1 is a diagram of a display device according to an exemplary embodiment of the present invention;

FIG. 2 is a diagram of a full color implementation principle by a time/space division method of the display device shown in FIG. 1 according to an exemplary embodiment of the present invention;

FIG. 3 is a diagram of a backlight unit shown in FIG. 1 according to an exemplary embodiment of the present invention;

FIG. 4 is a timing diagram illustrating an operation of the display device shown in FIG. 1 in a high-brightness mode according to an exemplary embodiment of the present invention;

FIG. 5 is a timing diagram illustrating an operation of the display device shown in FIG. 1 in a low-brightness mode according to an exemplary embodiment of the present invention;

FIG. 6 is a timing diagram when a first low-brightness maximum pulse width and a second low-brightness maximum pulse width are set differently from each other according to an exemplary embodiment of the present invention;

FIG. 7 is a diagram of a display device according to an exemplary embodiment of the present invention;

FIG. 8 is a timing diagram illustrating a changed pulse width of a second light control signal of the display device shown in FIG. 7 according to an exemplary embodiment of the present invention;

FIG. 9 is a diagram of a display device according to an exemplary embodiment of the present invention; and

FIG. 10 is a block diagram of a timing controller shown in FIG. 9 according to an exemplary embodiment of the present invention.

### DETAILED DESCRIPTION OF THE EMBODIMENTS

Hereinafter, exemplary embodiments of the present invention will be described in more detail with reference to the accompanying drawings. Like reference numerals in the drawings may denote like elements throughout the specification and drawings.

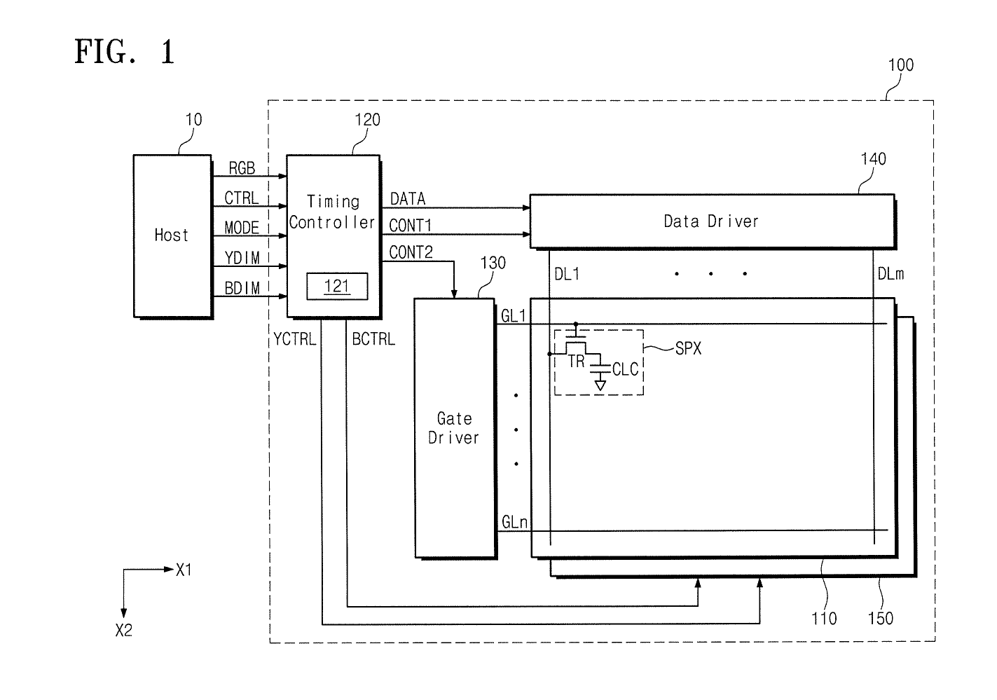

FIG. 1 is a diagram of a display device 100 according to an exemplary embodiment of the present invention.

Referring to FIG. 1, the display device 100 includes a display panel 110, a timing controller 120, a gate driver 130, a data driver 140, and a backlight unit 150. Each of the timing controller 120, the gate driver 130, and the data driver 140 are a display panel driving unit driving the display panel 110.

The display device 100 receives an image signal RGB, control signals CTRL, a mode signal MODE, and dimming signals YDIM and BDIM from a host 10. The mode signal MODE is a signal indicating a high brightness mode or a low brightness mode. The dimming signals YDIM and BDIM include a first dimming signal YDIM and a second dimming signal BDIM.

The display panel 110 includes a plurality of gate lines GL1-GLn extending in a first direction X1, a plurality of data lines DL1 to DLm extending in a second direction X2, which is substantially perpendicular to the first direction X1, and intersecting the gate lines GL1 to GLn, and a plurality of sub-pixels SPX arranged in a matrix in intersection areas of the gate lines GL1-GLn and the data lines DL1 to DLm (wherein n and m are natural numbers other than 0). The plurality of gate lines GL1 to GLn and the plurality of data lines DL1 to DLm are insulated from each other.

Each sub-pixel SPX includes a switching transistor TR and a liquid crystal capacitor (CLC). The switching transistor TR is connected to a corresponding data line and a corresponding gate line. The liquid crystal capacitor (CLC) is connected to the switching transistor TR.

The sub-pixels SPX have substantially the same structure as each other. Accordingly, by describing a configuration of one of the sub-pixels SPX, repeated description for configurations of other sub-pixel SPX will be omitted. The switching transistor TR of each sub-pixel SPX includes a gate electrode connected to a gate line GL1 among the plurality of gate lines GL1 to GLn, a source electrode connected to a data line DL1 among the plurality of data lines DL1 to DLm, and a drain electrode connected to one end of the liquid crystal capacitor CLC. Another end of the liquid crystal capacitor CLC may be connected to a common voltage. The switching transistor TR may include a thin film transistor.

The timing controller 120 receives an image signal RGB and control signals CTRL from the host 10. The control signals CTRL control a displaying of the image signal RGB. For example, the control signals CTRL include a vertical sync signal, a horizontal sync signal, a main clock signal, and a data enable signal. The timing controller 120 provides a data signal DATA and a first control signal CONT1 to the data driver 140 and provides a second control signal CONT2 to the gate driver 130. The data signal DATA may be a signal obtained by processing the image signal RBG to be fit for an operation condition of the display panel 110 on the basis of the control signals CTRL. The first control signal CONT1 may include a horizontal sync start signal, a clock signal, and a line latch signal. The second control signal CONT2 may include a vertical sync start signal, an output enable signal, and a gate pulse signal.

In addition, the timing controller 120 outputs a first light control signal YCTRL and a second light control signal BCTRL for controlling the backlight unit 150 in response to a mode signal MODE, a first dimming signal YDIM, and a second dimming signal BDIM.

The timing controller 120 includes a memory 121 for storing information corresponding to a pulse width (e.g., a maximum pulse width) of each of the first light control signal YCTRL and the second light control signal BCTRL. For example, the memory 121 may store high-brightness maximum pulse width information (e.g., information of the first and second light control signals YCTRL and BCTRL in a high brightness mode) and low-brightness maximum pulse width information (e.g., information of the first and second light control signals YCTRL and BCTRL in a low brightness mode) for each of the first light control signal YCTRL and the second light control signal BCTRL.

The data driver 140 outputs grayscale voltages for driving the data lines DL1 to DLm in response to the data signal DATA and the first control signal CONT1 provided by the timing controller 120.

The gate driver 130 drives the gate lines GL1 to GLn in response to the second control signal CONT2 provided by the timing controller 120. The gate driver 130 may include at least one gate driving integrated circuit (IC). The gate driver 130 may be implemented with an amorphous silicon gate (ASG) using an amorphous silicon thin film transistor (a-Si TFT) or a circuit using an oxide semiconductor, a crystalline semiconductor, a polycrystalline semiconductor, or the like.

When a gate-on voltage VON is applied to one of the gate lines GL1 to GLm, switching transistors in one row connected to the one of the gate lines are turned on. In this case, the data driver 140 provides grayscale voltages corresponding to the data signal DATA to the data lines DL1 to DLm. The grayscale voltages supplied to the data lines DL1 to DLm are applied to a corresponding sub-pixel through the turned-on switching transistor. Hereinafter, a period during which switching transistors in one row are turned on is referred to as ‘1 horizontal period’ or ‘1H’, which may correspond to one period of an output enable signal and a gate pulse signal.

The backlight unit 150 supplies light at the rear of the display panel 110. According to an exemplary embodiment of the present invention, the backlight unit 150 may include a plurality of light emitting diodes as a light source. In this case, the light emitting diodes may be arranged in a stripe along one direction on a printed circuit board (PCB) or may be arranged in a matrix.

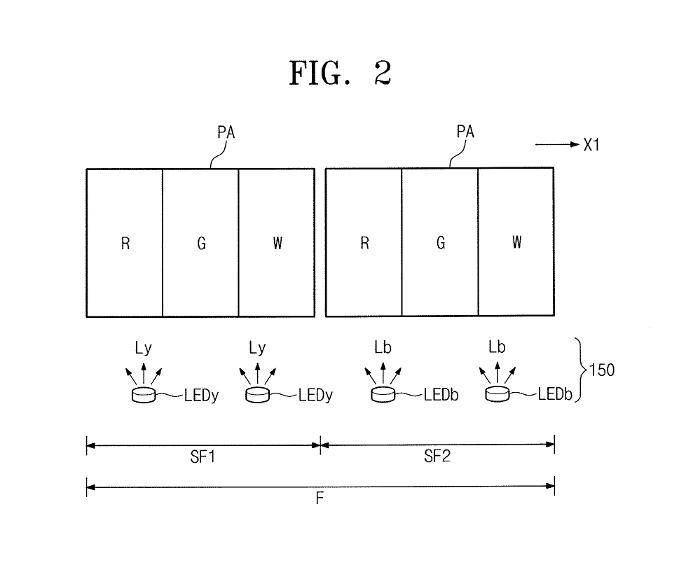

FIG. 2 is a diagram of a full color implementation principle by a time/space division method of the display device 100 shown in FIG. 1 according to an exemplary embodiment of the present invention.

Referring to FIG. 2, in the time/space division method, a first color filter R and a second color filter G having different colors from each other are included in the display panel 110 of FIG. 1 for full color implementation.

According to an exemplary embodiment of the present invention, the first color filter R is a red color filter having a red color and the second color filter G is a green color filter having a green color. However, in an exemplary embodiment of the present invention, the first color filter R and the second color filter G are not limited thereto. When an area corresponding to one pixel is defined as a pixel area PA, each pixel area PA includes the first color filter R and the second color filter G. In addition, an open part W corresponding to a white color is formed in each pixel area PA. For example, the open part W may be considered as a filter that passes any color (e.g., white color) of light. The first color filter R, the second color filter G, and the open part W are sequentially formed in the first direction X1. The first color filter R, the second color filter G, and the open part W correspond to three sub-pixels, respectively, in the pixel area PA. The open part W may be implemented with a transparent filter on substantially the same plane as the first color filter R and the second color filter G.

In addition, the backlight unit 150 of FIG. 1 includes a first light source LEDy for generating a first color light Ly and a second light source LEDb for generating a second color light Lb. A unit frame F includes a first sub frame SF1 and a second sub frame SF2 according to a temporal order. The first light source LEDy of the backlight unit 150 is driven during the first sub frame SF1. Therefore, the first color light Ly is provided to the display panel 110 during the first sub frame SF1. In addition, the second light source LEDb of the backlight unit 150 is driven in the second sub frame SF2. Therefore, the second color light Lb is provided to the display panel 110 during the second sub frame SF2. For example, when a frequency of the unit frame F is about 60 Hz, a frequency of the sub frame (e.g., the first sub frame SF1 and the second sub frame SF2) may be about 120 Hz.

According to an exemplary embodiment of the present invention, the first color light Ly provided from the first light source LEDy may be light having a yellow color (e.g., yellow light) and the second color light Lb provided from the second light source LEDb may be light having a blue color (e.g., blue light). When the first color light Ly is the yellow light, the first color light Ly may include red and green light components.

Accordingly, during the first sub frame SF, a red light component in the first color light Ly generated from the backlight unit 150 is displayed as a red image through the first color filter R and a green light component in the first color light Ly is displayed as a green image through the second color filter G. In addition, the first color light Ly passes through the open part W as it is and then is displayed as a yellow image.

Then, during the second sub frame SF2, the second color light Lb generated from the backlight unit 150 passes through the open part W and is displayed as a blue image.

In an exemplary embodiment of the present invention, the open part W corresponds to a space displaying a yellow image during the first sub frame SF1 and a blue image during the second sub frame SF2. When a yellow image and a blue image are alternately displayed through the open part W in a time division method, a white color may be displayed. Therefore, the open part W may reduce a color separation phenomenon occurring from a time division method and may increase brightness. A size of the open part W may be determined to have an appropriate transmittance in consideration of a desired brightness and a color of a frame.

In an exemplary embodiment of the present invention, red and green images are displayed through a space division method by the first color filter R and the second color filter G and yellow and blue images are alternately displayed through a time division method, and thus, the full color implementation may be achieved by the time/space division method.

When the full color implementation is achieved through the time/space division method, brightness of the backlight unit 150 may be adjusted by adjusting emitting times of the first color light Ly and the second color light Lb.

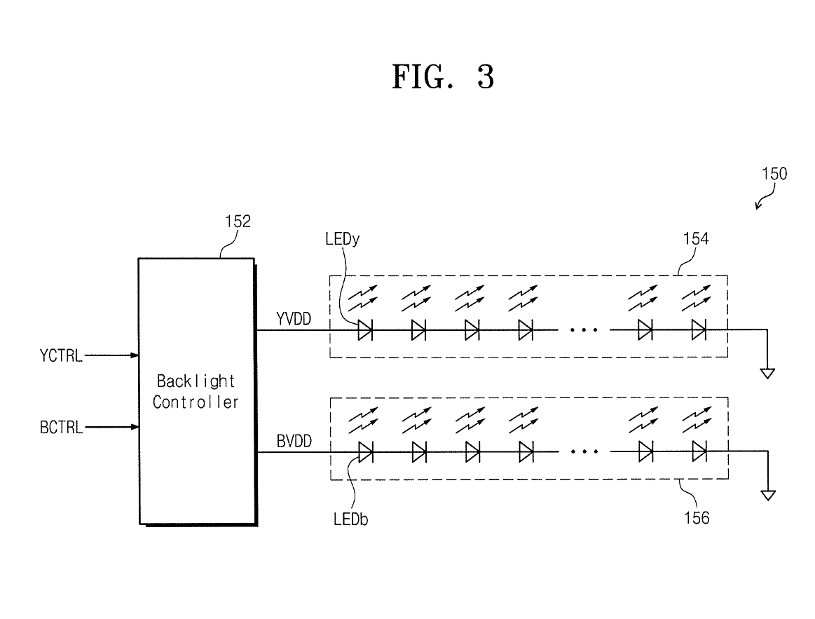

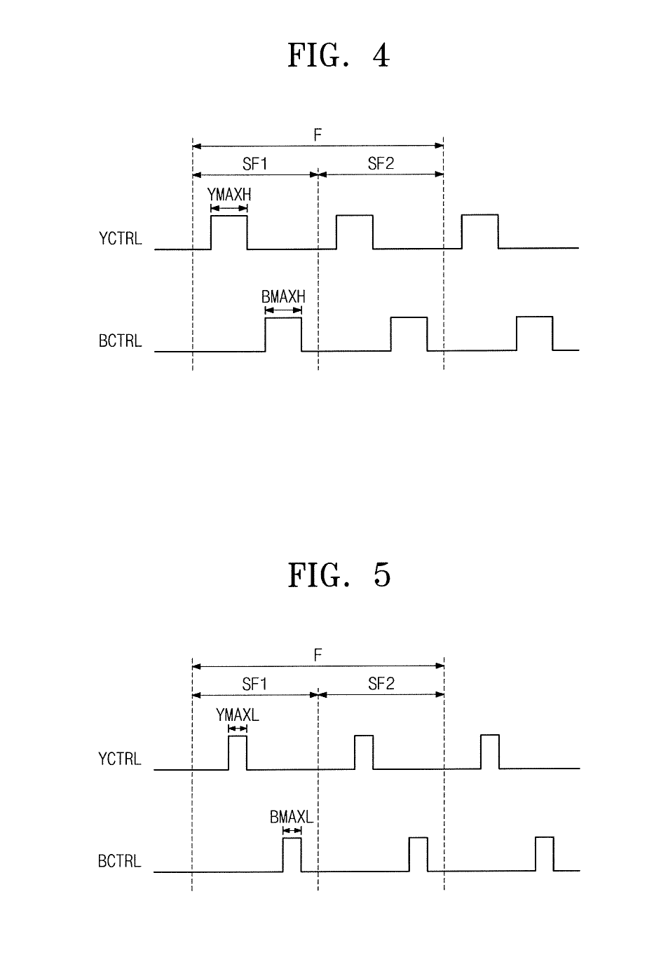

FIG. 3 is a diagram of a backlight unit 150 shown in FIG. 1 according to an exemplary embodiment of the present invention. FIG. 4 is a timing diagram illustrating an operation of the display device 100 shown in FIG. 1 in a high-brightness mode according to an exemplary embodiment of the present invention. FIG. 5 is a timing diagram illustrating an operation of the display device 100 shown in FIG. 1 in a low-brightness mode according to an exemplary embodiment of the present invention.

Referring to FIGS. 3 to 5, the backlight unit 150 includes a backlight controller 152, a first light source string 154, and a second light source string 156. The backlight controller 152 provides a first power voltage YVDD to the first light source string 154 in response to a first light control signal YCTRL. The backlight controller 152 provides a second power voltage BVDD to the second light source string 156 in response to a second light control signal BCTRL. For example, the backlight controller 152 provides the first power voltage YVDD to the first light source string 154 in response to the first light control signal YCTRL during the first sub frame SF1. The backlight controller 152 provides the second power voltage BVDD to the second light source string 156 in response to the second light control signal BCTRL during the second sub frame SF2. One frame F includes the first sub frame SF1 and the second sub frame SF2. The first sub frame SF1 and the second sub frame SF2 are continuous in time and are alternately repeated.

The first light source string 154 includes first light sources LEDy connected in series. The second light source string 156 includes second light sources LEDb connected in series. Each of the first light sources LEDy is a light emitting diode (LED) for emitting the first color light Ly. Each of the second light sources LEDb is an LED for emitting the second color light Lb.

Each of the first light control signal YCTRL and the second light control signal BCTRL maintains a high level during a predetermined time of the first sub frame SF11 and the second sub frame SF2. For example, each of the first light control signal YCTRL and the second light control signal BCTRL has a predetermined pulse width.

As shown in FIG. 4, during a high-brightness mode, a pulse width of the first light control signal YCTRL is set as a first high-brightness maximum pulse width YMAXH, and a pulse width of the second light control signal BCTRL is set as a second high-brightness maximum pulse width BMAXH. The first high-brightness maximum pulse width YMAXH and the second high-brightness maximum pulse width BMAXH are stored in the memory 121 of the timing controller 120 shown in FIG. 1.

When the mode signal MODE provided from the host 10 represents a high-brightness mode, the timing controller 120 sets the pulse widths of the first light control signal YCTRL and the second light control signal BCTRL in response to the first dimming signal YDIM and the second dimming signal BDIM, respectively. For example, when the first dimming signal YDIM is represented with 4 bits, the time controller 120 outputs the first light control signal YCTRL having a first pulse width corresponding to the first dimming signal YDIM. The first pulse width may be among 16 steps of pulse widths represented by 4 bits of the first dimming signal YDIM. For example, a maximum value of the 16 steps pulse widths may correspond to the first high-brightness maximum pulse width YMAXH. In addition, when the second dimming signal BDIM is represented with 4 bits, the time controller 120 outputs the second light control signal BCTRL having a second pulse width corresponding to the second dimming signal BDIM. The second pulse width may be among 16 steps of pulse widths represented by 4 bits of the second dimming signal BDIM. For example, a maximum value of the 16 steps pulse widths may correspond to the second high-brightness maximum pulse width BMAXH.

As shown in FIG. 5, during a low-brightness mode, a pulse width of the first light control signal YCTRL is set as a first low-brightness maximum pulse width YMAXL, and a pulse width of the second light control signal BCTRL is set as a second low-brightness maximum pulse width BMAXL. The first low-brightness maximum pulse width YMAXL and the second low-brightness maximum pulse width BMAXL are stored in the memory 121 of the timing controller 120 shown in FIG. 1.

When the mode signal MODE provided from the host 10 represents a low-brightness mode, the timing controller 120 sets the pulse widths of the first light control signal YCTRL and the second light control signal BCTRL in response to the first dimming signal YDIM and the second dimming signal BDIM, respectively. For example, when the first dimming signal YDIM is represented with 4 bits, the time controller 120 outputs the first light control signal YCTRL having a third pulse width corresponding to the first dimming signal YDIM. The third pulse width may be among 16 steps pulse widths represented by 4 bits of the first dimming signal YDIM. For example, a maximum value of the 16 steps pulse widths may correspond to the first low-brightness maximum pulse width YMAXL. In addition, when the second dimming signal BDIM is represented with 4 bits, the time controller 120 outputs the second light control signal BCTRL having a fourth pulse width corresponding to the second dimming signal BDIM. The fourth pulse width may be among 16 steps of pulse widths represented by 4 bits of the second dimming signal BDIM. For example, a maximum value of the 16 steps pulse widths may correspond to the second low-brightness maximum pulse width BMAXL.

Therefore, the display device 100 may change the brightness of the backlight unit 150 by adjusting the pulse widths of the first light control signal YCTRL and the second light control signal BCTRL in response to the mode signal MODE, the first dimming signal YDIM, and the second dimming signal BDIM, which are provided from the host 10.

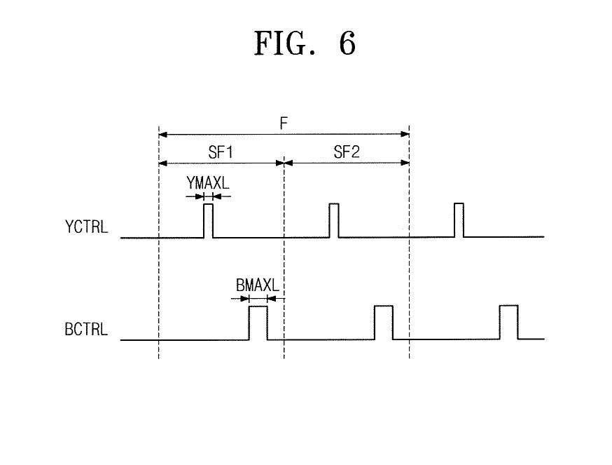

FIG. 6 is a timing diagram when a first low-brightness maximum pulse width and a second low-brightness maximum pulse width are set differently from each other according to an exemplary embodiment of the present invention.

When the display device 100 shown in FIG. 1 is located in an outdoor area, the brightness of the backlight unit 150 may be changed according to surrounding illumination (e.g., intensity of illumination). For example, when the intensity of the surrounding illumination is relatively strong (e.g., during the daytime when strong sunlight is present), the display device 100 operates in a high-brightness mode. When the intensity of the surrounding illumination is relatively weak (e.g., during the nighttime when no sunlight is present), the display device 100 operates in a low-brightness mode. For example, in consideration of the characteristic that brightness of a blue image is recognized as low in the night, the second low-brightness maximum pulse width BMAXL may be set broader than the first low-brightness maximum pulse width YMAXL (e.g., YMAXL<BMAXL).

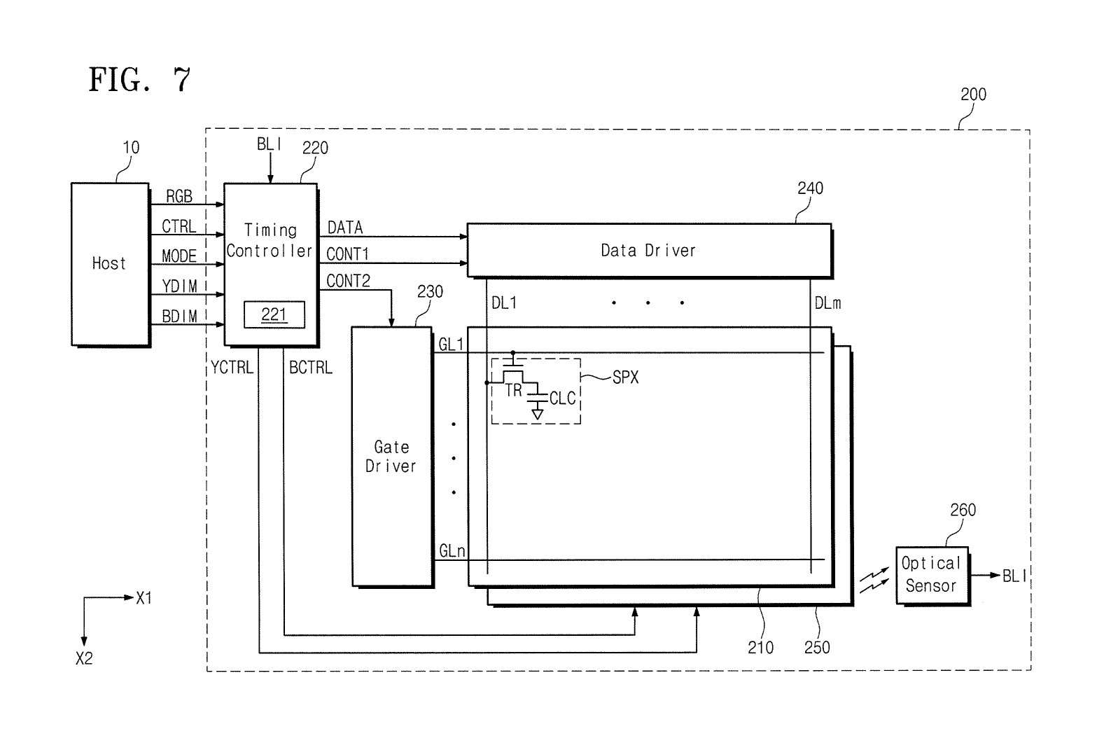

FIG. 7 is a diagram of a display device 200 according to an exemplary embodiment of the present invention.

Referring to FIG. 7, the display device 200 includes a display panel 210, a timing controller 220, a gate driver 230, a data driver 240, a backlight unit 250, and an optical sensor 260. Since the display panel 210, the timing controller 220, the gate driver 230, the data driver 240, and the backlight unit 250 are identical to those shown in FIG. 1, overlapping descriptions will be omitted.

The optical sensor 260 detects an amount of light emitted from the backlight unit 250 and outputs a light detection signal BLI. The light detection signal BLI is provided to the timing controller 220.

For example, when the display device 200 is used for a digital information display (DID) for digital signage such as personal digital photo frames, billboards for commercial advertise, or the like, or information desks used in public places, the display device 200 may continuously operate for a long time. Chemical properties of an LED used for the backlight unit 250 may change during the continuous and long operation time and thus a yellowish shift phenomenon in which white color coordinates are shown as a more yellow color may occur.

The timing controller 220 compares the data signal DATA provided to the data driver 140 and the light detection signal BLI received from the optical sensor 260. When a difference in level between the data signal DATA and the light detection signal BLI is greater than a predetermined reference value, the timing controller 220 recognizes that a yellowish shift phenomenon occurs and the pulse width of the second light control signal BCTL is changed to increase the brightness of blue light emitted from the backlight unit 250. For example, the timing controller 220 changes the second high-brightness maximum pulse width BMAXH and the second low-brightness maximum pulse width BMAXL stored in the memory 221 to change the pulse width of the second light control signal BCTRL.

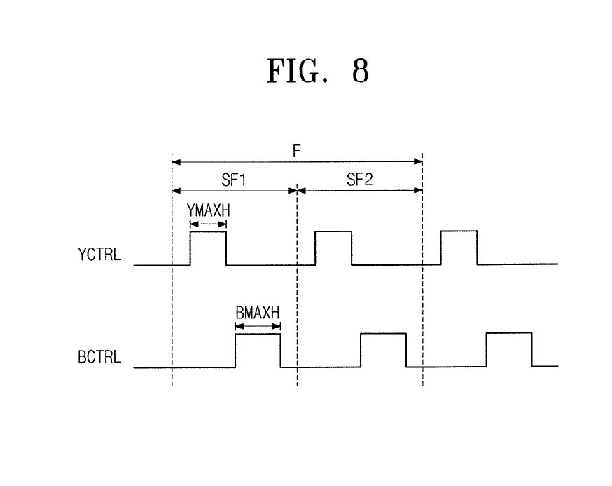

FIG. 8 is a timing diagram illustrating a changed pulse width of a second light control signal of the display device 200 shown in FIG. 7 according to an exemplary embodiment of the present invention.

Referring to FIGS. 7 and 8, when a difference in level between the data signal DATA and the light detection signal BLI is greater than a predetermined reference value, the timing controller 220 changes the second high-brightness maximum pulse width BMAXH stored in the memory 221. For example, during a high-brightness mode, the first high-brightness maximum pulse width YMAXH of the first light control signal YCTRL is narrower than the second high-brightness maximum pulse width BMAXH of the second light control signal BCTRL (e.g., YMAXH<BMAXH). Accordingly, even when the display device 200 operates for a long time, a desired image of a color temperature may be displayed.

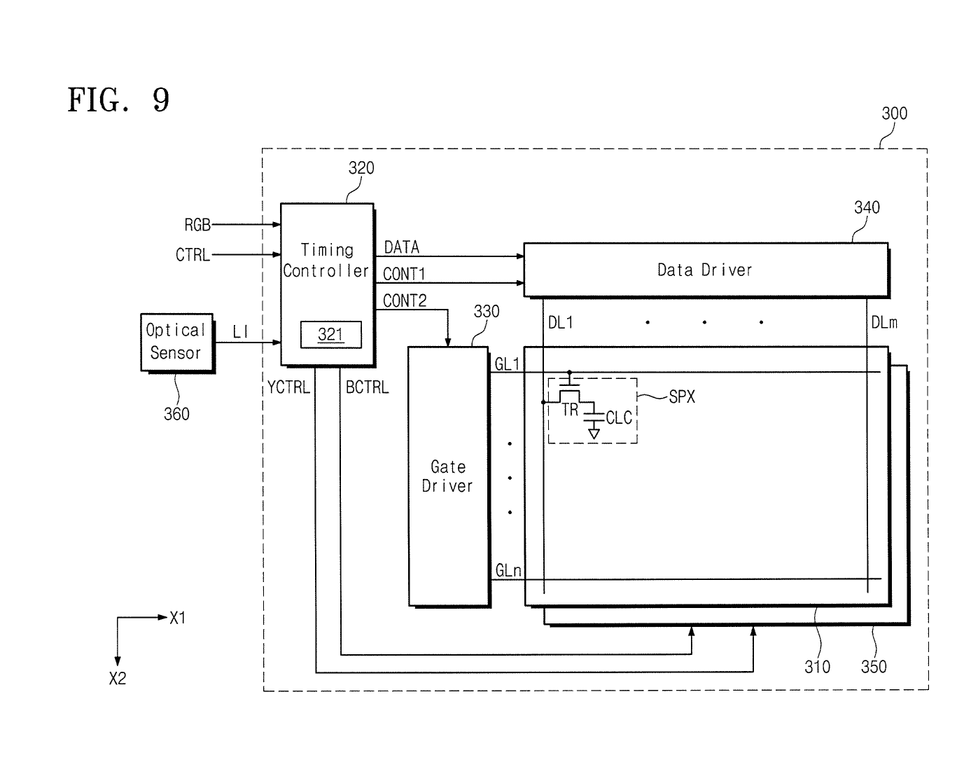

FIG. 9 is a diagram of a display device 300 according to an exemplary embodiment of the present invention.

Referring to FIG. 9, the display device 300 includes a display panel 310, a timing controller 320, a gate driver 330, a data driver 340, a backlight unit 350, and an optical sensor 360. Since the display panel 310, the gate driver 330, the data driver 340, and the backlight unit 350 are identical to those shown in FIG. 1, overlapping descriptions will be omitted.

When the display device 300 is located in an outdoor area, the brightness of the backlight unit 350 may be changed according to surrounding illumination (e.g., intensity of illumination). For example, when the intensity of the surrounding illumination is relatively strong (e.g., during the daytime when strong sunlight is present), the display device 300 operates in a high-brightness mode.

When the intensity of the surrounding illumination is relatively weak (e.g., during the nighttime when no sunlight is present), the display device 300 operates in a low-brightness mode. For example, in consideration of the characteristic that brightness of a blue image is recognized as low in the night, the second low-brightness maximum pulse width BMAXL may be set broader than the first low-brightness maximum pulse width YMAXL (e.g., YMAXL<BMAXL).

The optical sensor 360 detects an amount of light emitted from the backlight unit 300 and provides a light detection signal LI to the timing controller 320.

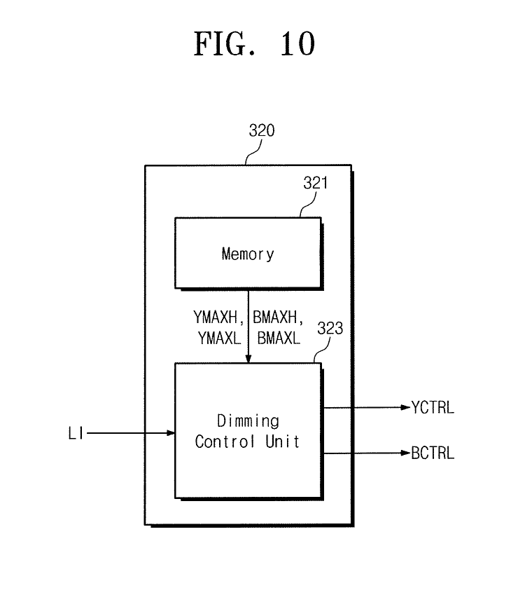

FIG. 10 is a block diagram of a timing controller 320 shown in FIG. 9 according to an exemplary embodiment of the present invention.

Referring to FIG. 10, the timing controller 320 includes a memory 321 and a dimming control unit 32. The memory 321 stores the first high-brightness maximum pulse width YMAXH and the first low-brightness maximum pulse width YMAXL of the first light control signal YCTRL and the second high-brightness maximum pulse width BMAXH and the second low-brightness maximum pulse width BMAXL of the second light control signal BCTRL. The dimming control unit 323 outputs the first light control signal YCTRL and the second light control signal BCTRL corresponding to the light detection signal LI by referring to the first high-brightness maximum pulse width YMAXH, the first low-brightness maximum pulse width YMAXL, the second high-brightness maximum pulse width BMAXH, and the second low-brightness maximum pulse width BMAXL stored in the memory 321.

When a signal level of the light detection signal LI is higher than a reference value, the timing controller 320 operates in a high-brightness mode. When a signal level of the light detection signal LI is lower than a reference value, the timing controller 320 operates in a low-brightness mode. In addition, according to a signal level of the light detection signal LI, the brightness of the backlight unit 350 may be adjusted.

The first light control signal YCTRL and the second light control signal BCTRL outputted from the dimming control unit 323 are substantially identical to those shown in FIGS. 4 and 5.

When a signal level of the light detection signal LI is higher than a reference value, as shown in FIG. 4, the dimming control unit 323 outputs the first light control signal YCTRL by referring to the first high-brightness maximum pulse width YMAXH and outputs the second light control signal BCTRL by referring to the second high-brightness maximum pulse width BMAXH.

When a signal level of the light detection signal LI is lower than a reference value, as shown in FIG. 5, the dimming control unit 323 outputs the first light control signal YCTRL by referring to the first low-brightness maximum pulse width YMAXL and outputs the second light control signal BCTRL by referring to the second low-brightness maximum pulse width BMAXL.

The timing controller 120 shown in FIG. 1 determines the pulse widths of the first light control signal YCTRL and the second light control signal BCTRL in response to the first dimming signal YDIM and the second dimming signal BDIM. The dimming control unit 323 shown in FIG. 10 determines the pulse widths of the first light control signal YCTRL and the second light control signal BCTRL according to a signal level of the light detection signal LI. For example, the brightness of the backlight unit 350 may be controlled by adjusting the pulse widths of the first light control signal YCTRL and the second light control signal BCTRL according to intensity of surrounding illumination.

A display device according to an exemplary embodiment of the present invention may adjust operation timings of a blue light source and a yellow light source in a backlight unit therein. Accordingly, when the display device operates for a long time, quality of an image displayed on the display device may be decreased.

In addition, the display device may adjust the operation timings of the blue light source and the yellow light source in response to a dimming signal provided from the outside. Therefore, brightness of a backlight unit may be adjusted according to an external illumination (e.g., the surrounding illumination).

The foregoing is illustrative of exemplary embodiments of the present invention and the present invention should not be construed as being limited to the exemplary embodiments disclosed herein. Although a few exemplary embodiments have been described, it will be understood that various modifications in forms and detail may be made therein without departing from the spirit and scope of the present invention.

What is claimed is:

1. A display device comprising:
a display panel driving unit configured to generate a data signal to display an image on a display panel of the display device and to output a first light control signal and a second light control signal in response to a mode signal; and
a backlight unit configured to provide first light having a first color to the display panel in response to the first light control signal, and to provide second light having a second color different from the first color to the display panel in response to the second light control signal,
wherein the display panel driving unit adjusts a pulse width of the first light control signal or a pulse width of the second light control signal in response to the dimming signal.

2. The display device of claim 1, wherein
the dimming signal comprises a first dimming signal and a second dimming signal,
wherein the display panel driving unit adjusts the pulse width of the first light control signal in response to the mode signal and the first dimming signal, and adjusts the pulse width of the second light control signal in response to the mode signal and the second dimming signal.

3. The display device of claim 2, wherein
the display panel displays the image by a unit of a frame,
wherein the display panel driving unit outputs the first light control signal to emit the first light in a first sub frame of the unit of the frame, and outputs the second light control signal to emit the second light in a second sub frame of the unit of the frame.

4. The display device of claim 3, wherein the backlight unit comprises:
a first light source for providing the first light;
a second light source for providing the second light; and
a backlight controller for driving the first light source in response to the first light control signal and for driving the second light source in response to the second light control signal.

5. The display device of claim 3, wherein the display panel comprises a plurality of sub-pixels, a plurality of gate lines, and a plurality of data lines, each of the plurality of sub-pixels connected to one of the plurality of gate lines and one of the plurality of data lines,
wherein the display panel driving unit comprises:
a gate driver for driving the plurality of gate lines;
a data driver for driving the plurality of data lines; and
a timing controller for controlling the gate driver and the data driver, and outputting the first light control signal and the second light control signal in response to the first dimming signal and the second dimming signal, respectively.

6. The display device of claim 1, wherein the display panel driving unit comprises a memory for storing a first high-brightness pulse width and a first low-brightness pulse width corresponding to the first light control signal, and storing a second high-brightness pulse width and a second low-brightness pulse width corresponding to the second light control signal.

7. The display device of claim 6, further comprising an optical sensor detecting an amount of light from the backlight unit and outputting a light detection signal based on the detected amount of the light,
wherein the display panel driving unit adjusts the first high-brightness pulse width, the first low-brightness pulse width, the second high-brightness pulse width, or the second low-brightness pulse width based on a first difference in level between the data signal and the light detection signal.

8. The display device of claim 7, wherein the display panel driving unit adjusts the second high-brightness pulse width to be broader than the first high-brightness pulse width when the first difference is greater than a reference value.

9. The display device of claim 6, wherein the display panel driving unit outputs the first light control signal having a first pulse width corresponding to the first high-brightness pulse width, and outputs the second light control signal having a second pulse width corresponding to the second high-brightness pulse width when the mode signal indicates a high-brightness mode.

10. The display device of claim 6, wherein the display panel driving unit outputs the first light control signal having a first pulse width corresponding to the first diming signal by referring to the first low-brightness pulse width, and outputs the second light control signal having a second pulse width corresponding to the second diming signal by referring to the second low-brightness pulse width when the mode signal indicates a low-brightness mode.

11. The display device of claim 10, wherein the second pulse width is broader than the first pulse width.

12. The display device of claim 5, further comprising an optical sensor detecting an amount of light from the backlight unit and outputting a light detection signal based on the detected amount of the light,
wherein the timing controller adjusts a pulse width of the first light control signal or a pulse width of the second light control signal in response to the light detection signal.

13. The display device of claim 1, wherein the display panel comprises:
a plurality of sub-pixels;
a first color filter;
a second color filter; and
an open part,
wherein the first color filter, the second color filter, and the open part are sequentially arranged in a first direction in one-to-one correspondence to the sub-pixels.

14. The display device of claim 13, wherein the first color filter is a red color filter and the second color filter is a green color filter.

15. The display device of claim 1, wherein the first color is a yellow color and the second color is a blue color.

16. A display device comprising:
a display panel displaying an image;
a backlight unit configured to provide first light having a first color to the display panel in response to a first light control signal, and to provide second light having a second color different from the first color to the display panel in response to a second light control signal;
a timing controller configured to output the first light control signal and the second light control signal in response to a light detection signal; and
an optical sensor configured to detect an amount of light emitted from the backlight unit and to output a light detection signal based on the amount of the light.

17. The display device of claim 16, wherein a pulse width of the first light control signal or a pulse width of the second light control signal is adjusted according to a level of the light detection signal.

18. The display device of claim 16, wherein the timing controller comprises a memory for storing pulse width information of the first and second light control signals.

19. The display device of claim 18, wherein the timing controller further comprises a dimming control unit for outputting the first and second light control signals based on both of the light detection signal and the pulse width information.

20. The display device of claim 16, wherein the first color is a yellow color and the second color is a blue color.
